(19) United States
(12) Patent Application Publication
(10) Pub. No.: US 2015/0354704 A1
(43) Pub. Date: Dec. 10, 2015

(54) V-RING SEAL WITH BIASING MEMBER

(71) Applicants: Yefim Epshetsky, Schaumburg, IL (US); Gregory G. Gildea, Village of Lakewood, IL (US); Maria Concepcion Martin, Madrid (ES)

(72) Inventors: Yefim Epshetsky, Schaumburg, IL (US); Gregory G. Gildea, Village of Lakewood, IL (US); Maria Concepcion Martin, Madrid (ES)

(73) Assignee: Aktiebolaget SKF, Goteborg (SE)

(21) Appl. No.: 14/298,178

(22) Filed: Jun. 6, 2014

(51) Int. Cl. F16J 15/32

(52) U.S. Cl. CPC F16J 15/3208

(57) ABSTRACT

A seal assembly is for sealing a space between first and second members, the first member having a central axis and an outer circumferential surface extending about the axis, the second member having a radially-extending axial surface. The seal assembly includes a generally annular elastomeric seal body disposed about the first member outer surface and extending circumferentially about the central axis, the body including a base portion and a sealing portion having an inner end integrally formed with the base portion and an outer, free end sealingly engageable with the second member axial surface, a generally annular cavity being defined between the base portion and the sealing portion. A biasing member is disposed within the annular cavity and is configured to exert a generally radially-inwardly directed force on the seal body so as to substantially prevent relative angular displacement between the seal body and the first member.

### BACKGROUND OF THE INVENTION

The present invention relates to seals, and more particularly to V-ring seals for sealing against axial surfaces.

V-ring axial seals are known and typically include an annular elastomeric body having a main body portion and a cantilever-like sealing portion extending from the main body portion. The seal body is disposed on a shaft or other mechanical member and the sealing portion engages with an axial surface of another mechanical member so as to seal an axial space between the shaft/member and the other member. The seal body has a central bore that receives a portion of the shaft/member, which is sized such that there is an interference fit between the body and the shaft/member. This interference fit is important in order to prevent relative angular displacement between the seal body and the shaft/member as either the shaft/member, or the other member which the sealing portion engages, typically rotates about a central axis.

To ensure a proper interference fit, the seal body may be formed as a molded annular body having an appropriately sized central bore. However, in applications where the seal body must be installed about an assembly that does not allow insertion of the shaft/member into the bore, the body is typically formed as an elongated flexible body having ends coupled together to form the annular seal body. In such cases, the desired interference fit is established by cutting the elongated body to a length that is substantially lesser than the circumference about which the seal is installed, and then the body is stretched to a significant extent prior to connecting the body ends. Such an installation process requires special tooling and training to properly install the seal and connect the body ends, and often leads to distortion of the formed seal body.

### SUMMARY OF THE INVENTION

In one aspect, the present invention is a seal assembly for sealing a space between first and second members. The first member has a central axis and an outer circumferential surface extending about the axis and the second member has a radially-extending axial surface. The seal assembly comprises a generally annular elastomeric seal body disposed about the first member outer surface and extending circumferentially about the central axis. The body includes a base portion and a sealing portion having an inner end integrally formed with the base portion and an outer, free end sealingly engageable with the second member axial surface. A generally annular cavity is defined between the base portion and the sealing portion. Further, a biasing member is disposed within the annular cavity and is configured to exert a generally radially-inwardly directed force on the seal body so as to substantially prevent relative angular displacement between the seal body and the first member.

In another aspect, the present invention is an assembly comprising a first member having a central axis and an outer circumferential surface extending about the central axis and a second member spaced axially from the first member such that a space is defined between the first and second members. The second member has a radially-extending axial surface facing generally toward the first member. A seal is for sealing the space and includes a generally annular elastomeric seal body disposed about the first member outer surface and extending circumferentially about the shaft central axis. The seal body includes a base portion and a sealing portion having an inner end integrally formed with the base portion and an outer end sealingly engageable with the second member axial surface. A generally annular cavity is defined between the base portion and the sealing arm portion. Further, a biasing member is disposed within the annular cavity and configured to bias the sealing portion generally axially toward the second member axial surface so as to substantially prevent relative angular displacement between the seal body and the first member.

In a further aspect, the present invention is again a seal assembly for sealing a space between first and second members. The first member has a central axis and an outer circumferential surface extending about the axis and the second member has a radially-extending axial surface. The seal assembly comprises a generally annular elastomeric seal body disposed about the first member outer surface and extending circumferentially about the central axis. The seal body includes a base portion, the base portion having two opposing axial ends and inner and outer circumferential surfaces, the inner surface being sealingly engaged with the first member outer surface, and a sealing portion. The sealing portion has an inner end integrally formed with one of the two base portion axial ends and an outer, free end sealingly engageable with the second member axial surface. A generally annular cavity is defined between the base portion and the sealing portion. Further, a biasing member is disposed within the annular cavity and is configured to exert a generally radially inwardly directed force on the seal body.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a machine assembly having a seal assembly in accordance with the present invention;

FIG. 2 is a broken-away, enlarged view of an upper portion of FIG. 1;

FIG. 3 is an axial cross-sectional view of an annular seal body;

FIG. 4 is a perspective view of a flexible elongated body preferably used to form the annular seal body;

FIG. 5 is a front plan view of a presently preferred construction of a biasing member formed generally as a garter spring;

FIG. 6 is a broken-away, axial cross-sectional view of a windmill hub assembly including four seal assemblies of the present invention;

FIG. 7 is an enlarged view of a portion of FIG. 6, showing one of the four seal assemblies;

FIG. 8 is a more diagrammatic view of a first member and a flexible elongated body, showing the seal body in an unbended state;

FIG. 9 is another more diagrammatic view of the first member and the elongated body, showing the seal body partially bended about the first member; and

FIG. 10 is yet another more view of the first member and the elongated body, showing the seal member completely bended about the first member with ends coupled together to form the annular seal body.

### DETAILED DESCRIPTION OF THE INVENTION

Certain terminology is used in the following description for convenience only and is not limiting. The words “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

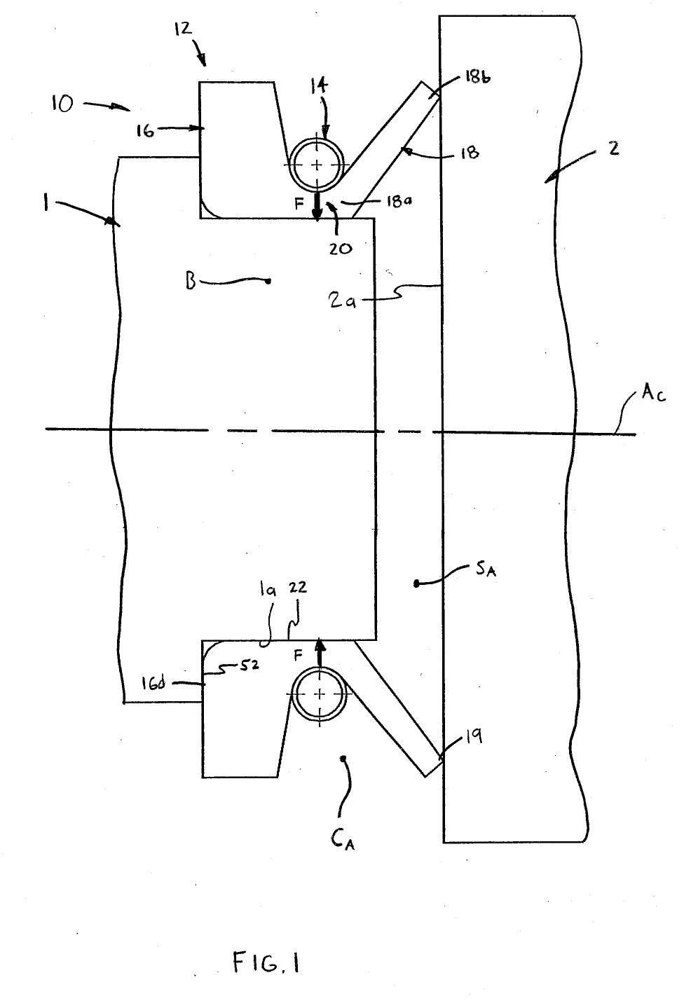

Referring now to the drawings in detail, wherein like numbers are used to indicate like elements throughout, there is shown in FIGS. 1-10 a seal assembly 10 for sealing a space S_{A}, which is typically axial, between first and second members 1, 2, respectively. The first member 1 has a central axis A_{C} and an outer circumferential surface 1a extending about the axis A_{C}, and the second member 2 has a radially-extending axial surface 2a generally adjacent to the outer surface 1a. The seal 10 basically comprises a generally annular elastomeric seal body 12 and a biasing member 14. The annular elastomeric seal body 12 has a central bore B (FIG. 11), is disposed about the first member outer surface 1a and extends circumferentially about the central axis A_{C}; in other words, a portion of the first member 1 is disposed within the seal body central bore B.

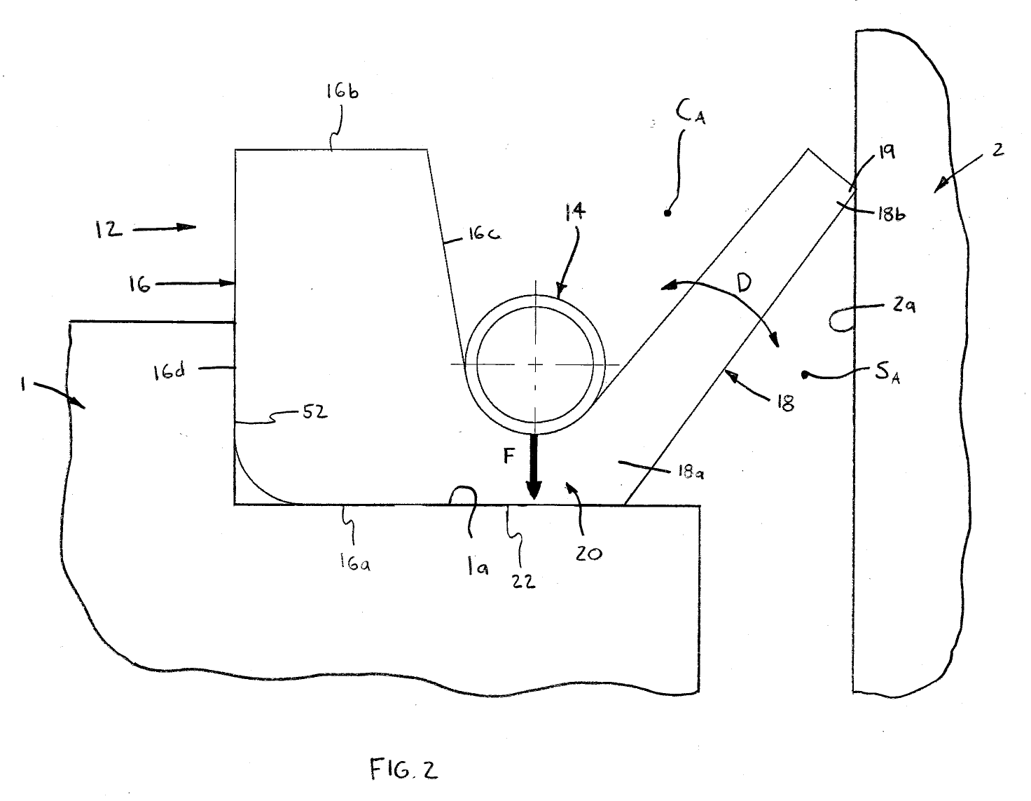

The body 12 includes a base portion 16 and a sealing portion 18 having an inner end 18a integrally formed with the base portion 16 and an outer, free end 18b with an axial lip 19 sealingly engaged or engageable with the second member axial surface 2a. A generally annular cavity C_{A} is defined between the base portion 16 and the sealing portion 18 and the body 12 preferably further includes an integral hinge portion 20 connecting the sealing portion 18 with the base portion 16. As such, the sealing portion 18 is deflectable about the hinge portion 20 in generally axial directions with respect to the base portion 16, as indicated by arrow D in FIG. 2.

Further, the biasing member 14 is disposed within the annular cavity C_{A} and is configured to exert a generally radially-inwardly directed force F on the seal body 12 so as to substantially prevent relative angular displacement between the seal body 12 and the first member 1. In other words, the pressure or force F exerted by the biasing member 14 on the seal body 12 couples the body 12 with the first member 1; i.e., by friction between the seal body 12 and the first member 1. As such, whether the first member 1 rotates with respect to the second member 2 or the second member 2 rotates with respect to a fixed first member 1, the seal body 12 remains fixed relative to the first member 1 and the sealing portion 18 remains sealingly engaged with the second member axial surface 2a. Furthermore, the seal body 12 has an inner circumferential surface 22 sealingly engaged with the outer surface 1a, so as to prevent fluid flow, or movement of solid particles, between the seal assembly 10 and the first member 1. As such, the biasing force F exerted on the seal body 12 also functions to provide sealing pressure at the interface between the seal body inner surface 22 and the first member outer surface 1a.

As best shown in FIG. 10, the seal body 12 preferably has two opposing ends 12a, 12b coupled together to form the annular body 12. Specifically, the seal body 12 is preferably formed as a flexible, generally straight elongated body 11, most preferably an elastomeric extrusion, prior to the coupling of the two ends 12a, 12b, as depicted in FIGS. 4 and 8. The elongated seal body 11 has a linear distance or length L_{B} between the two ends 12a, 12b when the ends 12a, 12b are uncoupled and the body 11 is in a generally “straightened” state, as indicated in FIGS. 4 and 8. The annular seal body 12 is preferably formed with minimal or no extension of the elongated body 11, such that when the two ends 12a, 12b are coupled together, the circumference of the annular body 12 has a value approximately equal to the value of the linear distance or length L_{B}. Preferably, the amount of extension or “stretching” of the body 11 is minimized such that the increase in the circumference value is within about zero percent (0%) of the linear distance value and about three percent (3%) of the linear distance value.

Referring now to FIGS. 1, 2 and 5, the biasing member 14 is generally annular and extends circumferentially about the central axis A_{C}, such that the force F applied to the seal body 12 is distributed substantially uniformly about the circumference of the body 12. Preferably, the biasing member 14 is a garter spring 24, which is most preferably formed of a coil spring 26 having a tapered end 26a and an opposing, standard or “untapered” end 26b. With such a biasing member 14, the straight or “unbended” coil spring 26 is preferably first positioned within the annular cavity C_{A} of the seal body 12 and then bended circumferentially about the central axis A_{C} and stretched until the spring ends 26a, 26b are generally in contact. Next, the tapered end 26a is then threaded into the untapered end 26b until the two ends 26a, 26b remain connected together. Although the described biasing member construction is presently preferred, the biasing member 14 may be formed in any other appropriate manner capable of functioning as generally described herein.

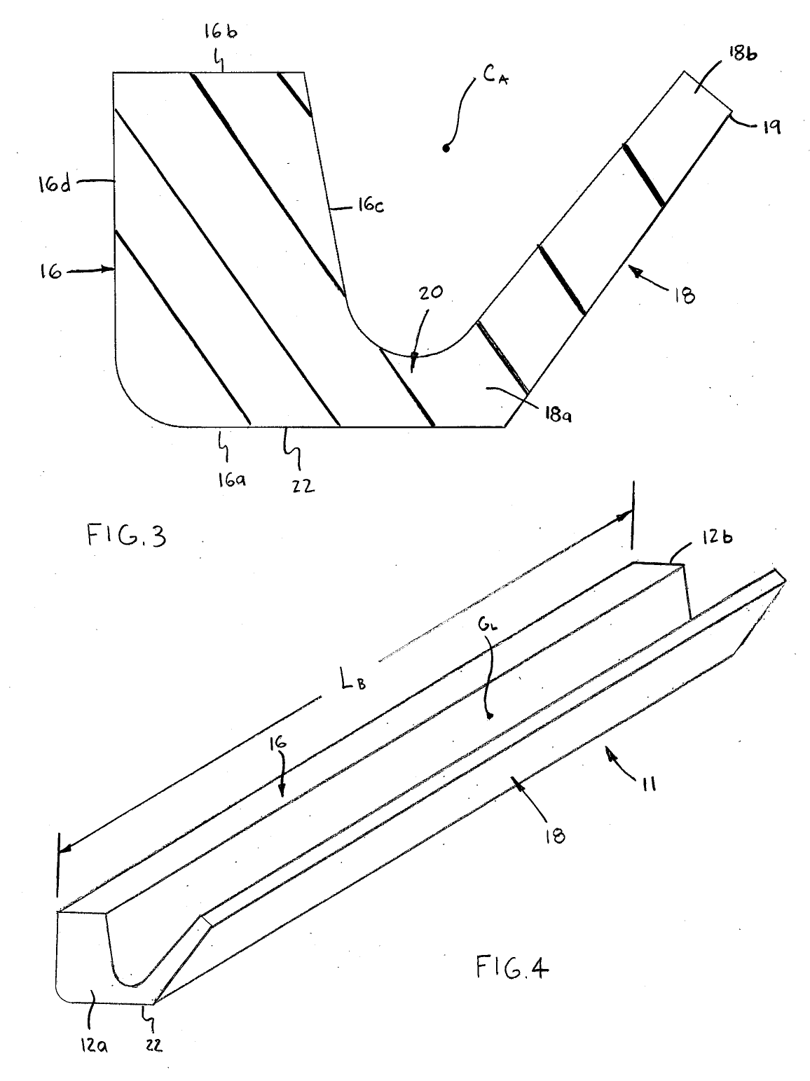

Referring to FIGS. 1-4, the annular elastomeric seal body 12 is preferably formed as a conventional “V-ring” seal. As such, the elastomeric body 12 has generally V-shaped axial cross-sections, i.e., cross-sections taken along the axis A_{C}, as best shown in FIG. 3. More specifically, the base portion 16 has a generally rectangular cross-sectional shape and the sealing portion 18 is preferably generally cantilever-like in cross-section, with the joint portion 20 extending generally axially between the two sections 16, 18. Further, the body base portion 16 has inner and outer circumferential surfaces 16a, 16b and opposing inner and outer axial ends 16c, 16d. With this structure, the inner end 18a of the body sealing portion 18 is integrally formed with the base inner axial end 16c at a position proximal to the base inner surface 16a, most preferably being coupled by the integral hinge portion 20. As such, the sealing portion 18 extends from the sealing portion inner end 18a to the sealing portion outer, free end 18b both generally radially outwardly from, and generally axially away from, the body base portion 16. However, the seal body 12 may have any appropriate shape that includes a generally cantilever-like section for sealing axially against a radially-extending surface.

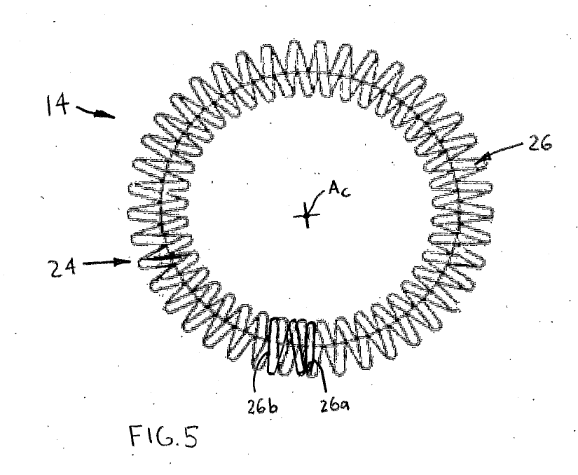

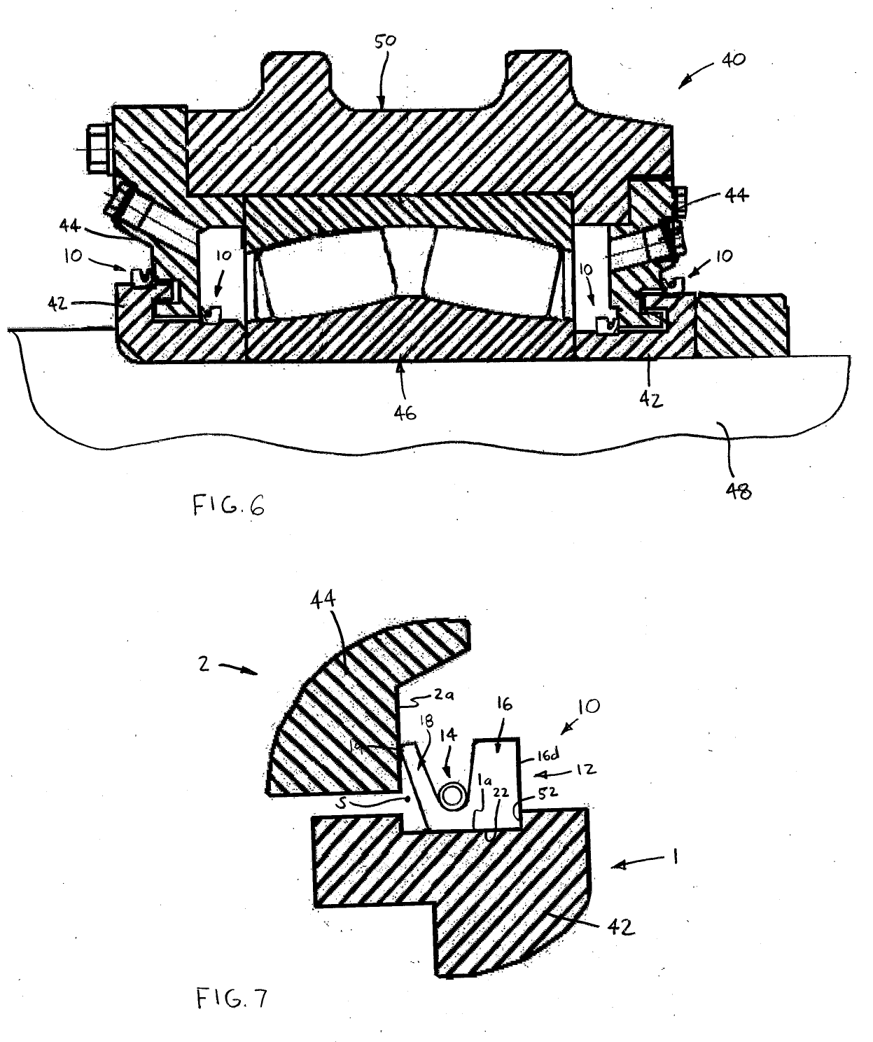

Referring to FIGS. 1, 2, 6 and 7, the seal assembly 10 may be used in any application, machine, vehicle, etc., in which is it is desired to seal a space S_{A} between first and second members 1, 2. For example, in one presently preferred application of the seal assembly 10, four assemblies 10 are used in a windmill bearing assembly 40 in which each first member 1 is a labyrinth seal ring 42 and each second member 2 is a cover 44, as shown in FIGS. 6 and 7. The windmill bearing assembly 44 includes a rolling element bearing 46 mounted on a shaft 48 and disposed within a housing 50, such that the seal assemblies 10 prevent ingress of contaminants into the bearing 46 and egress of lubricant from the bearing 46. However, the depicted example is presented for purposes of illustration only, and the seal assembly 10 may be used in any application where it is desired to seal axially against a generally radially-extending surface.

In any application, the first member 1 preferably has a generally radially-extending shoulder surface 52 adjacent to the circumferential surface 1a and the outer axial end 16d of the seal body base portion 16 is preferably disposed against the shoulder surface 52, as shown in FIGS. 1, 2 and 7. As such, the seal body 12 is essentially “sandwiched” between the shoulder surface 52 and the second member axial surface 2a, which prevents axial displacement of the seal assembly 10. However, the seal assembly 10 may also be used in applications in which the annular body 12 is unsupported, i.e., where there is no shoulder surface 52, and is instead axially retained solely by friction generated by the force F that the biasing member 14 exerts on the body 12.

Having described the structure above, the seal assembly 10 is preferably formed generally as follows, particularly for applications in which the assembly 10 must be installed within an at least partially assembled machine preventing installation of a “pre-formed” annular seal body 12. First, an elongated elastomeric body 11 is provided, the body 11 having opposing axial ends 12a, 12b and an elongated V-shaped groove G_{L} extending between the ends 12a, 12b, as best shown in FIG. 4. Preferably, the circumference of the first member 1 at the outer surface 1a is first determined (i.e., measured or calculated) and then the body 11 is sized (e.g., by cutting, etc.), such that the length L_{B} of the body 11 is about equal to the circumference of the first member 1 at the outer surface 1a. The biasing member 14 is also provided, preferably as a coil spring 26 as described above.

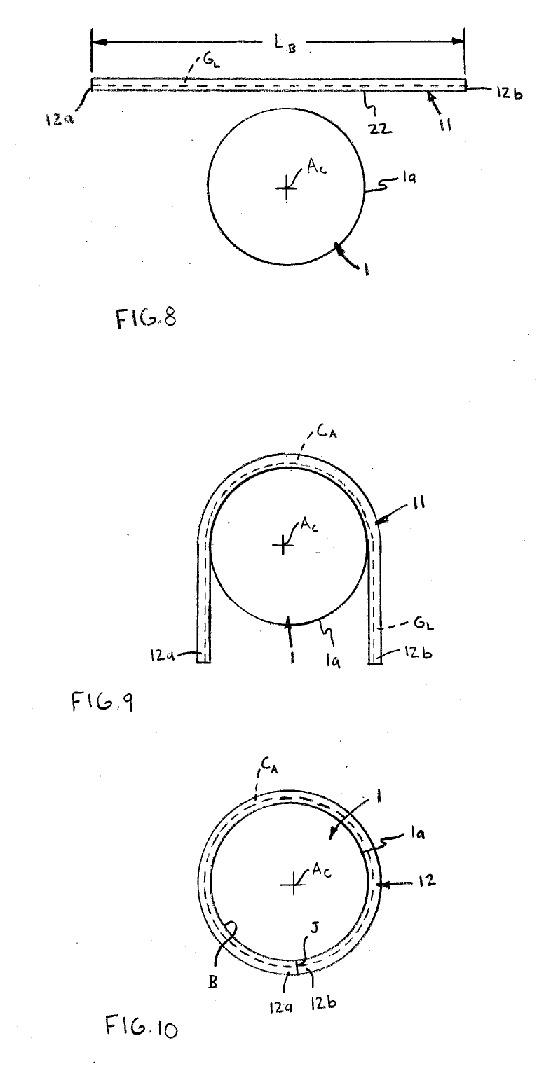

Next, the elongated body 11 is positioned adjacent to the first member 1 (FIG. 8) such that the body inner sealing surface 22 contacts the first member outer surface 1a and the groove G_{L} faces generally outwardly away from the first member 1. The body 11 is then bended circumferentially about the first member 1, in other words, bended around the circumferential outer surface 1a to extend a complete circuit about the axis A_{C}, as shown in FIGS. 8 and 9, during which process the elongated groove G_{L} forms the annular cavity C_{A}. Then, the ends 12a, 12b of the elongated body 11 are coupled to form the annular seal body 12, preferably by applying an adhesive to at least one of the two elongated body ends 12a, 12b and holding the ends 12a, 12b together until the adhesive sets or hardens to form a solid joint J (FIG. 10). However, the ends 12a, 12 by may be coupled together in other appropriate manner, such as by use of fasteners, melted by applied heat, etc.

At this point, the biasing member 14 is then positioned within the groove or annular cavity C_{A} such that the biasing member 14 exerts a radially-inwardly directed force F on the annular seal body 12, to thereby prevent relative angular displacement between the seal body 12 and the first member 1. Preferably, the biasing member 14 is installed by bending the coil spring 26 circumferentially and completely about the axis A_{C} and coupling the ends 26a, 26b of the spring 26 by any appropriate means to form the annular biasing member 14, which is generally similar to a conventional garter spring 24. Then, the completed seal assembly 10 may be displaced axially relative to the first member 1, if necessary, to position the seal body 12 such that the axial lip 19 at the body sealing portion outer end 18b is sealingly engaged with the second member axial surface 2a.

Although the seal assembly 10 is formed generally as described above, in certain applications, the annular seal body 12 may be pre-formed in any appropriate manner and then installed about the first member 1 by inserting the first member 1 into the bore of the seal body 12. The biasing member 14 may either be installed within the groove G_{L}/cavity C_{A} prior to installation of the body 12 on the first member, or assembled after in a manner as described above.

The seal assembly 10 is clearly advantageous over prior art V-ring seals. By providing the biasing member 14 to prevent angular displacement of the body 12 relative to the first member 1, the seal body 12 may be sized about equal to, or slightly lesser than, the circumference of the first member 1. As such, little or no extension or stretching of the elongated body 11 is required when forming the annular seal body 12 of the seal assembly 10, therefor eliminating the necessity of using special tooling to stretch and hold the ends 12a, 12b of the body 11. Thus, the seal assembly 10 is simpler to install and substantially eliminates the potential for localized deformations of the seal body 12.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

1. A seal assembly for sealing a space between first and second members, the first member having a central axis and an outer circumferential surface extending about the axis, the second member having a radially-extending axial surface, the seal assembly comprising:
a generally annular elastomeric seal body disposed about the first member outer surface and extending circumferentially about the central axis, the body including a base portion and a sealing portion having an inner end integrally formed with the base portion and an outer, free end sealingly engageable with the second member axial surface, a generally annular cavity being defined between an inner axial end of the base portion and the sealing portion; and
a biasing member disposed within the annular cavity, sized to simultaneously contact both the inner axial end of the base portion and the sealing portion and configured to exert a generally radially-inwardly directed force on the seal body so as to substantially prevent relative angular displacement between the seal body and the first member.

2. The seal assembly as recited in claim 1 wherein the seal body has an inner circumferential surface sealingly engaged with the first member.

3. The seal assembly as recited in claim 1 wherein the seal body has two opposing ends coupled together to form the annular body.

4. The seal assembly as recited in claim 3 wherein the seal body is formed as an elongated elastomeric body prior to coupling of the two ends.

5. The seal assembly as recited in claim 4 wherein the elongated body has a linear distance between the two ends when the ends are uncoupled, the linear distance having a value, and the two ends are coupled together such that the circumference of the annular body has a value approximately equal to the linear distance value.

6. The seal assembly as recited in claim 5 wherein an increase in the circumference value is within about zero percent (0%) of the linear distance value and about three percent (3%) of the linear distance value.

7. The seal assembly as recited in claim 1 wherein the biasing member is generally annular and extends circumferentially about the central axis.

8. The seal assembly as recited in claim 1 wherein the biasing member is a garter spring.

9. The seal assembly as recited in claim 1 wherein the elastomeric seal body has generally V-shaped axial cross-sections.

10. The seal assembly as recited in claim 1 wherein the body base portion has inner and outer circumferential surfaces and opposing axial ends, the inner end of the body sealing portion being integrally formed with one of the two base axial ends proximal to the base inner surface such that the sealing portion extends from the sealing portion inner end to the sealing portion outer end both generally radially outwardly from and generally axially away from the base portion.

11. The seal assembly as recited in claim 1 wherein the body further includes an integral hinge portion connecting the sealing portion with the base portion such that the sealing portion is deflectable in generally axial directions with respect to the base portion.

12. An assembly comprising:
a first member having a central axis and an outer circumferential surface extending about the central axis;
a second member spaced axially from the first member such that a space is defined between the first and second members, the second member having a radially-extending axial surface facing generally toward the first member; and
a seal for sealing the space and including:
a generally annular elastomeric seal body disposed about the first member outer surface and extending circumferentially about the shaft central axis, the seal body including a base portion and a sealing portion having an inner end integrally formed with the base portion and an outer end sealingly engageable with the second member axial surface, generally annular cavity being defined between an inner axial end of the base portion and the sealing portion; and
a biasing member disposed within the annular cavity, sized to simultaneously contact both the inner axial end of the base portion and the sealing portion and configured to bias the sealing portion generally axially toward the second member axial surface so as to substantially prevent relative angular displacement between the seal body and the first member.

13. The assembly as recited in claim 12 wherein the first member further has a generally radially-extending shoulder surface adjacent to the circumferential surface and the seal body base portion has two opposing axial ends, the seal body sealing portion extending from one of the two base portion axial ends and the other one of the two base portion axial ends being disposed against the first member shoulder surface.

14. The assembly as recited in claim 12 wherein the seal body has an inner circumferential surface sealingly engaged with the first member outer surface.

15. The assembly as recited in claim 12 wherein the seal body has two opposing ends coupled together to form the annular body.

16. The assembly as recited in claim 15 wherein the body has a linear distance between the two ends when the ends are uncoupled, the linear distance having a value, and the two ends are coupled together such that the circumference of the annular body has a value approximately equal to the linear distance value.

17. The assembly as recited in claim 12 wherein the biasing member is a garter spring.

18. The seal assembly as recited in claim 12 wherein the elastomeric seal body has generally V-shaped axial cross-sections.

19. A seal assembly for sealing a space between first and second members, the first member being disposed about a shaft and the second member having a radially-extending axial surface, the seal comprising:
a generally annular elastomeric seal body disposed about the shaft, coupled with the first member and extending circumferentially about a central axis, the body including a base portion, the base portion having two opposing, inner and outer axial ends and inner and outer circumferential surfaces, the inner surface being sealingly engaged with the first member outer surface, and a sealing portion having an inner end integrally formed with the inner end of the base portion and an outer, free end sealingly engageable with the second member axial surface, a generally annular cavity being defined between the inner end of the base portion and the sealing portion; and
a biasing member disposed within the annular cavity, sized to simultaneously contact both the inner axial end of the base portion and the sealing portion and configured to exert a generally radially inwardly directed force on the seal body.

20. The seal assembly as recited in claim 19 wherein the force exerted by the biasing member substantially prevents relative angular displacement between the seal body and the first member.
